(19) United States
(12) Patent Application Publication
(10) Pub. No.: US 2019/0238532 A1
(43) Pub. Date: Aug. 1, 2019

(54) AUTHENTICATION SYSTEM UTILIZING SECONDARY CONNECTION

(71) Applicant: Salesforce.com, inc., San Francisco, CA (US)

(72) Inventors: Joshua David Alexander, Austin, TX (US); Evan Tyler Grim, Austin, TX (US)

(21) Appl. No.: 15/885,154

(22) Filed: Jan. 31, 2018

(51) Int. Cl. H04L 29/06; H04W 12/06; H04L 9/08

(52) U.S. Cl. CPC H04L 63/0853; H04L 63/107; H04W 4/02; H04L 9/08; H04L 2463/082; H04W 12/06

(57) ABSTRACT

Embodiments are disclosed relating to authenticating a user of a client computer system. One embodiment may include an application, executing on a client computer system, receiving an indication that a user is requesting access to a server computer system. In response to the receiving, the application may detect that a mobile device of the user is connected to a wireless network to which the client computer system is also connected. The application may receive authentication information for the request from the detected mobile device. The application may then send an authentication request to the server computer system. The authentication request may include data based on the authentication information received from the detected mobile device.

### BACKGROUND

### Technical Field

Embodiments described herein are related to the field of server access, and more particularly to the implementation of authentication systems.

### Description of the Related Art

Identity theft is an ongoing problem for individuals and businesses with any presence on the Internet. Accurately identifying and authorizing a user attempting to access a secure account on an online server helps to mitigate risks associated with identity theft and keep private or restricted information safe from unauthorized users. Users may access any number of online servers, such as, for example, database servers, financial services, online shopping, social media, and the like. To access these servers, a user may enter account credentials to verify their identity to the server. Identity thieves and hackers, however, have various methods for gaining knowledge of a user's account credentials, prompting some online businesses to increase authentication security.

One method used to improve authentication systems is multi-factor authentication. As on example, after a user enters account credentials in an attempt to access a particular server, the server may then request additional information from the user. For example, the server may send a passcode to a device registered to the user. In this example, access to the particular server may be granted only if the correct account credentials and passcode are entered.

### BRIEF DESCRIPTION OF THE DRAWINGS

FIG. 1 illustrates a block diagram of an embodiment of a user authentication system.

FIG. 2 shows a block diagram of another embodiment of a user authentication system.

FIG. 3 depicts a flow diagram for an embodiment of a method for authenticating a user on a client computer system.

FIG. 4 illustrates a flow diagram for another embodiment of a method for authenticating a user on a client computer system.

FIG. 5 shows a flow diagram for an embodiment of a method for generating authentication information on a mobile device.

FIG. 6 is a block diagram illustrating an exemplary environment for a multitenant database system, according to some embodiments.

### DETAILED DESCRIPTION

Use of multi-factor authentication schemes is one method that online service providers use in an attempt to accurately identify account owners and other users of their online services. One form of multi-factor authentication is to contact a secondary computing device (e.g., a mobile device) that the user registers with the account upon a new account creation. For example, a user may enter typical account credentials (e.g., a user identification (UID) and password) into an account sign-in user interface (UI) and if the credentials are valid, the server sends a code to the registered mobile device (e.g., a mobile phone, tablet computer, wearable device, or other similar device). The user reads the code from the mobile device and enters it into the UI. Such an approach, however, requires the user to have the mobile device in their possession and to physically type in the additional code. In addition, the code is frequently sent to the mobile device via a short message service (SMS) protocol as a text message. SMS text messaging is not considered secure by security experts as these messages are vulnerable to being intercepted.

Other forms of multi-factor authentication may automate permission requests by allowing a registered mobile device to respond to a permission request from a server without user input. U.S. patent application Ser. No. 14/849,312, filed Sep. 9, 2015, entitled “Automated Authorization Response Techniques”, and which is hereby incorporated herein by reference in its entirety, teaches techniques that allow a user to, during one permission request, give permission to automate future permission requests to the mobile device. In this manner, a login request to a particular server from a particular location that has been previously approved by a user may be automatically approved by the user's mobile device in response to a message sent by an authorization server.

Various embodiments of an authentication technique and authentication system are presented herein. The disclosed embodiments may be used in a stand-alone manner or as one authentication method in a multi-factor authentication scheme in order to provide increased security over other techniques. These disclosed embodiments may, for example, be combined with other authentication techniques to provide a multi-factor authentication scheme, including one that does not require a user to enter a passcode via a mobile device.

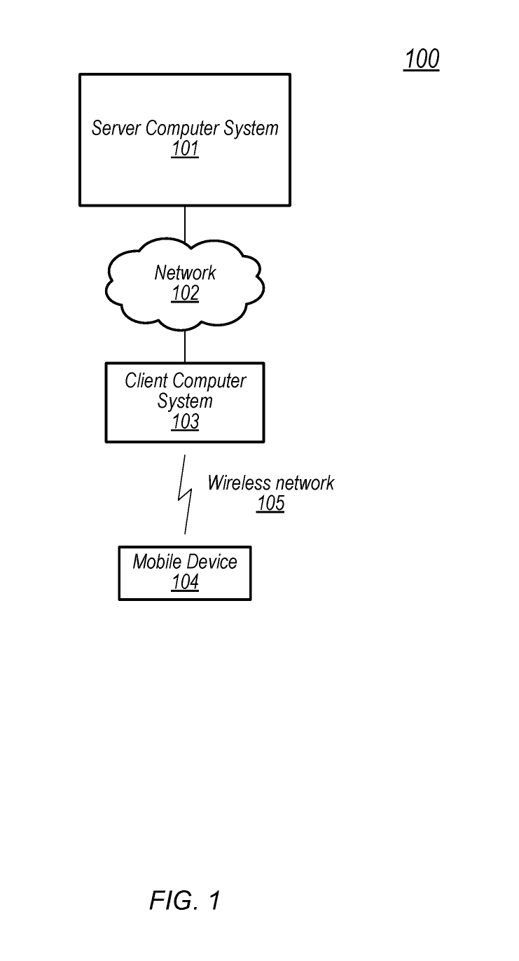

FIG. 1 illustrates a block diagram of an embodiment of a system of networked devices that may be used in a user authentication scheme. System 100 includes server computer system 101 coupled to client computer system 103 via network 102. In the illustrated embodiment, server computer system 201 corresponds to any suitable computer system or network of computer systems that may store information and/or provide services to a plurality of users via network 102. Network 102 corresponds to any suitable wide area network, such as the Internet, for connecting online servers to client computer systems. In addition to being coupled to server computer system 101, client computer system 103 is coupled to mobile device 104 via wireless network 105. Client computer system 103 may correspond to any computing device capable of communicating over network 102 and wireless network 105. In various embodiments, client computer system may correspond to a desktop computer, a laptop computer, a tablet computer, a smartphone, and the like. Mobile device 104 may similarly correspond to any mobile computing device including, but not limited to, a tablet computer, a smartphone, and a wearable smart device (e.g. a smart watch).

In the illustrated embodiment, a user of client computer system 103 attempts to login to an online account hosted on server computer system 101. The user may enter account credentials into a login interface displayed on client computer 103. These account credentials are then sent to server computer system 101 via network 102. In response to receiving the account credentials, server computer system 101 verifies the received credentials and, if the credentials are valid, sends an indication to client computer system 103 signifying that the user is requesting access. An application executing on client computer system 103 receives the indication that the user is requesting access to server computer system 101. In response to receiving the indication, client computer 103, using wireless network 105, detects that mobile device 104 is also connected to wireless network 105. The user may register mobile device 104 with the online account when the account is established or at another point in time before the current attempt to access the online account.

It is noted that, as used herein, “online” refers to a connected state of a server computer, computer system, mobile device, or other computing device, to a wide area network, such as, for example, the Internet. A computing device said to be “online” when it is capable of being accessed by, or accessing, other computing devices connected to the network. In reference to an account, “online” refers to a user account that is hosted by an online server or other type of online computing device, and, accordingly, may be accessed via the wide area network.

Client computer system 103, in the illustrated embodiment, determines that mobile device 104 is connected to the same wireless network 105 as client computer system 103. Wireless network 105 may be implemented with any suitable wireless networking protocol. Such protocols may include, for example, Bluetooth, ZigBee (or other protocols supporting the IEEE 802.15.4 standard), WiFi Direct, near-field communication (NFC), Radio-frequency identification (RFID), and other short-range wireless networks. The term “short-range wireless network” is to be understood for purposes of this disclosure according to its ordinary and accepted meaning the art, stands in contrast to a wide-area network, and includes, for example, wireless personal area network (WPANs). Rather than referring to the maximum range of the wireless network protocol, the connection between client computer system 103 and mobile device 104 can alternately be characterized as a peer-to-peer connection in some cases, meaning that system 103 and device 104 communicate without centralized coordination by another device. In many cases, this peer-to-peer communication may be performed by direct communication between system 103 and device 104.

By determining that mobile device 104 is coupled to wireless network 105, client computer system 103 may assume that mobile device 104 is physically within range of wireless network 105. For example, wireless network 105, in some embodiments, corresponds to a Bluetooth® or Bluetooth Low Energy (BLE) network, allowing peer-to-peer communication between client computer system 103 and mobile device 104. Depending on a class of radio used for the Bluetooth network, a communication range for a Bluetooth connection may reach 100 meters in some embodiments, while 10 meters is a common range for mobile devices such as smart phones and tablet computers. Maximum range may be reached in an open field, while the range may be reduced inside a home or office where walls, electrical appliances, and other active wireless networks create interference for the Bluetooth link. BLE, a lower power version of Bluetooth, may have a shorter range than Bluetooth. Using a Bluetooth or BLE protocol, therefore, allows client computer system 103 to determine that mobile device 104 is likely to be less than 100 meters from client computer system 103, and more commonly, to be within 10 meters. This determination of the general proximity of mobile device 104 to client computer system 103 increases a probability that the user that is requesting access to sever computer system 101 has mobile device 104 in their possession, or at least nearby, and is, therefore, the authorized user of the online account and not a hacker or identity thief located miles/kilometers away from registered mobile device 104.

Client computer system 103, in response to detecting mobile device 104 on wireless network 105, receives authentication information for the request from mobile device 104. In one embodiment, client computer system 103 may receive an identification (ID) value associated with mobile device 104, such as, for example, a Bluetooth ID, a device ID, a serial number, or any similar hardware ID that identifies mobile device 104. This hardware ID value may be used by client computer system 103 to generate data for an authentication request. Client computer system 103 then sends, this authentication request, including the data based on the authentication information, to the server computer system 101 via network 102. In some embodiments, the data may be encrypted by client computer system 103 before it is sent. If the data in the authentication request corresponds to data stored by server computer system 101, then access may be granted to the user of client computer system 103.

In some embodiments, user input on mobile device 104 may be requested before the authentication information is sent to client computer system 103. In other embodiments, authentication information may be sent to client computer system 103 passively, i.e., without user input on mobile device 104. This passive option may be enabled by the user during a first, or subsequent, non-passive authentication request, for example, by selecting an option presented on a display of mobile device 104 during the non-passive authentication request. It is noted that a passive option may be allowable due to the determination that mobile device 104 is in proximity to client computer system 103. If, instead of using client computer system 103 to communicate with mobile device 104, server computer system 101 communicated with mobile device 104 directly, e.g., via an Internet or cellular connection, then a determination that mobile device 104 is near client computer system 103 may not be possible, and therefore, the indication that the user of client computer system 103 is the actual account owner is missing.

It is noted that the embodiment of FIG. 1 is merely an example. The illustrated components are limited to those for describing the disclosed concepts. In other embodiments, additional components may be included.

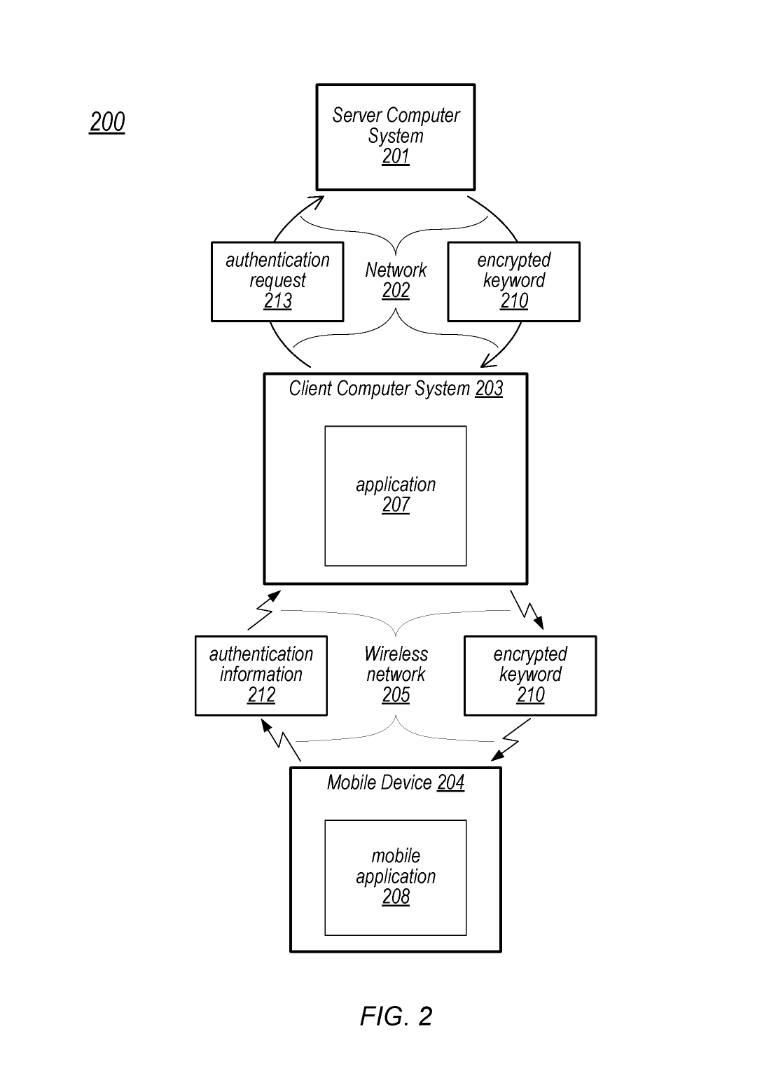

In the above example, an ID value associated with mobile device 104 is used as the basis for data used in the authentication request. An ID value, in some embodiments, may not provide an adequate level of security for generating the authentication request. Turning to FIG. 2, another embodiment of a system of networked devices that may be used in a user authentication scheme is shown. Networked system 200 includes components similar to the embodiment of FIG. 1, including server computer system 201 coupled to client computer system 203, which in turn, is coupled to mobile device 204 via wireless network 205. Descriptions and behavior of these components are as described above except as noted otherwise below. In this illustrated embodiment, client computer system 203 is executing application 207 and mobile device 204 includes mobile application 208.

Similar to the embodiment, of FIG. 1, a user of client computer system 203 may attempt to access an account hosted by server computer system 201 via network 202. In the illustrated embodiment, the user, by way of application 207, accesses an account login page provided by server computer system 201. In various embodiments, application 207 may correspond to a web browser application or an application specifically developed for holders of accounts on server computer system 201 to request access to the online account. The user may, for example, use the web browser to access an account login page provided by server computer system 201. In other embodiments, the user may select a login option in the application that results in a login interface to be displayed. The user enters account credentials that are sent, by application 207, to server computer system 201.

After validating the user's credentials, server computer system 201 sends a response to application 207. The response includes an encrypted version of keyword 210. Neither application 207 nor client computer system 203, in the illustrated embodiment may possess a key for decrypting keyword 210. Instead, application 207 sends the encrypted version of keyword 210 to mobile device 204 via wireless network 205. To send the encrypted version of keyword 210, application 207 may first detect that mobile device 204 is connected to wireless network 205.

In some embodiments, the response from server computer system 201 may include, in addition to the encrypted version of keyword 210, additional program instructions. For example, if application 207 is a web browser, then server computer system 201 may send a Java (or other scripting language) applet that may be executed within the framework of application 207, providing addition capabilities to application 207. In one embodiment, such an applet may provide application 207 a capability to access a wireless interface included in client computer system 203.

Wireless network 205 may correspond to any type of networking protocol, such as described above for wireless network 105. In one embodiment, for example, wireless network 205 may correspond to a WiFi network. Since a WiFi network may include global access across the Internet, application 207 may determine that mobile device 204 is connected directly to a same WiFi access point as client computer system 203. In the illustrated embodiment, wireless network 205 corresponds to a Bluetooth network. If application 207 corresponds to a web browser, then the web browser may include support for a Web Bluetooth application programming interface (API) that allows a web browser to send and receive data over a Bluetooth network connected to client computer system 203. If application 207 determines that client computer system 203 and mobile device 204 are connected to the same wireless network 205, then application 207 causes client computer system 203 to send a message including an encrypted version of keyword 210 to mobile device 204.

In various embodiments, mobile device 204 may be executing mobile application 208, or launches mobile application 208 in response to receiving a message from application 207 that includes the encrypted version of keyword 210. For example, a background process related to mobile application 208 may be executing on mobile device 204 before mobile application 208 is launched. The background process may detect the reception of the encrypted version of keyword 210, and subsequently cause mobile application 208 to be launched.

Mobile application 208, in the illustrated embodiment, possesses a cryptographic key that may be used to decrypt the encrypted version of keyword 210, thereby generating a decrypted version of the keyword. In various embodiments, this cryptographic key may be stored on mobile device 204 when mobile application 208 is installed, or after mobile device 204 has been registered by the user with the account on server computing system 201. In some embodiments, mobile application 208 may receive an updated cryptographic key at a periodic time interval, or after a predetermined number of uses of a current key. In other embodiments, mobile application 208 may utilize a rolling code scheme in which the cryptographic key is changed each time an encrypted version of a keyword is received and decrypted, and authentication information is sent in reply. In various embodiments, the cryptographic key may be selected by the user or randomly assigned by server computer system 201.

In one embodiment, mobile device 204 may not possess the cryptographic key when the encrypted version of keyword 210 is received. Instead, mobile device 204 may receive the cryptographic keyword independently from server computer system 201. For example, server computer system 201 may separately send the cryptographic key to mobile device 204 using the Internet where mobile device 204 receives the cryptographic key via a WiFi or cellular data connection (e.g., Long Term Evolution (LTE) connection). In some embodiments, server computer system 201 may send the cryptographic key via a text message. In such embodiments, the cryptographic key may be different for each use.

After the encrypted version of keyword 210 has been decrypted, mobile application 208 generates authentication information 212 using the decrypted version of the keyword. In various embodiments, authentication information 212 may include, but not be limited to, any of: the decrypted version of the keyword, the keyword re-encrypted with a different key, a modified version of the keyword (e.g., a two's complement of the keyword), an encrypted and modified version of the keyword, a keyword from a lookup table using the decrypted version of the keyword as an index into the lookup table, or a combination thereof. Mobile application 208 may utilize any suitable response that demonstrates that mobile application 208 successfully decrypted the received the encrypted version of keyword 210. Mobile application 208 causes mobile device 204 to send authentication information 212 to client computer system 203. In some embodiments, user input on mobile device 204 may be requested before mobile application 208 either generates authentication information 212, or sends authentication information 212 to client computer system 203. In other embodiments, authentication information 212 may be generated and sent to client computer system 203 passively, i.e., without user input on mobile device 204.

In the illustrated embodiment, application 207 receives authentication information 212, and uses this information to generate data that is included in authentication request 213. The generated data, in some embodiments, may include authentication information 212 as it was received from mobile device 204. In other embodiments, however, authentication information may be based on the data received from the mobile device—for example it may be modified, such as being encrypted by application 207 before being added to authentication request 213. Application 207 causes client computer system 203 to send authentication request 213 to server computer system 201. After receiving authentication request 213, server computer system validates the data included in the request corresponds to a mobile device that is registered to the account that the user is attempting to access. If the data from authentication request 213 is valid, e.g., matches an expected response, then access to the account is granted to the user of client computer system 203. Otherwise, some or all of the login process may be repeated one or more times before the account is locked due to multiple failures to successfully authenticate.

It is noted that using a value such as the Bluetooth ID in the example of FIG. 1 may not provide adequate security for some accounts, such as, for example, accounts with sensitive personal information or financial/banking information. The Bluetooth ID may be susceptible to known attacks, making it easier for a hacker to gain access to it. In contrast, the encrypted version of keyword 210 may be generated randomly, making it more difficult for even the user to know, as well as a hacker to discover. For an additionally level of security, server computer system 201 may, in some embodiments, generate a new keyword for each attempted access, thereby changing a value of authentication information 212 (and consequently, authentication request 213) for each attempted access. If a hacker manages to observe communication between client computer system 203 and either mobile device 204 or server computer system 201, any data the hacker monitors won't produce a valid access on a subsequent login attempt after the user completes the current login attempt.

It is also noted that the system of FIG. 2 is an example for demonstrative purposes. In other embodiments, additional components may be included, such as, for example, additional applications on any of the server, client computer, or mobile device.

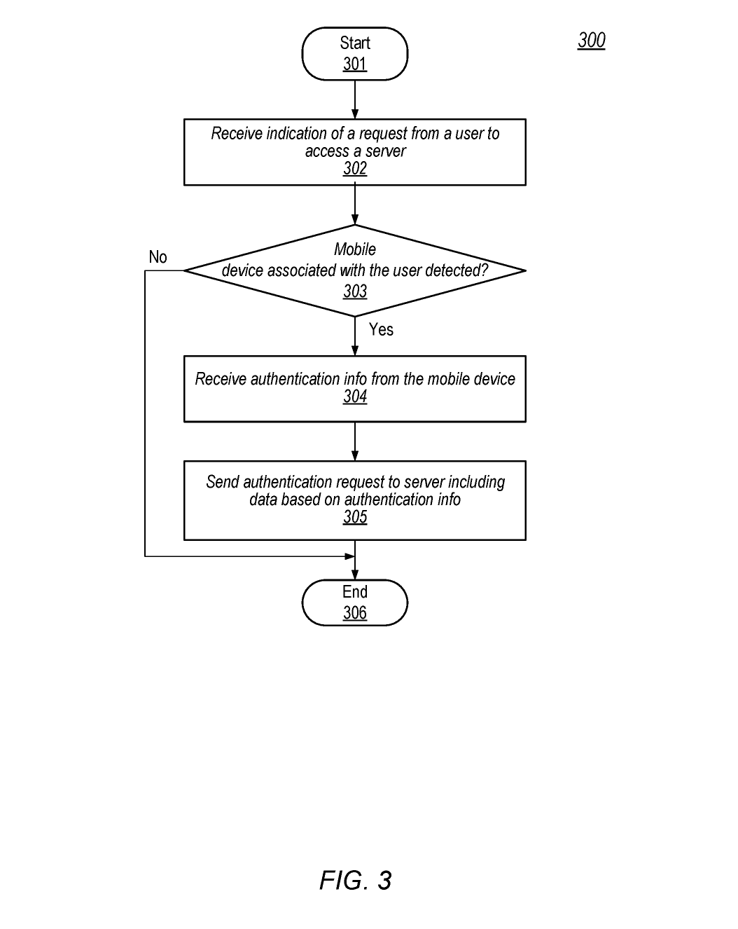

Moving to FIG. 3, a flow diagram is depicted for an embodiment of a method for authenticating a user accessing a server. Method 300 may be applied to a client computer, such as, for example, client computer systems 103 or 203 in FIGS. 1 and 2. Referring collectively to FIG. 1 and method 500, the method starts in block 301.

An application executing on a client computer system receives an indication that a user is requesting access to a server computer system (block 302). In the illustrated embodiment, a user attempts to login to server computer system 101 using client computer system 103. In some embodiments, the user may attempt to login user a web browser or other application to send account credentials to server computer system 101. In other embodiments, the user may launch an application that contacts server computer system 101. Server computer system 101, after receiving the account credentials or other contact from the application, sends the indication to client computer system 103 that an account is being accessed. In some embodiments, this indication may include information such as, for example, a challenge codeword for which server computer system 101 expects a particular response in order to grant access to the account. In one embodiment, the particular response corresponds to a value to be provided by a mobile device that is registered on the account.

Further operations of the method may depend on detection of a mobile device (block 303). In response to receiving the indication, the application detects that a mobile device of the user is connected to a wireless network to which the client computer system is also connected. In the illustrated embodiment, client computer system 103 attempts to contact mobile device 104 using wireless network 105. If client computer system 103 detects that mobile device 104 is connected to wireless network 105, then the method moves to block 304 to receive authentication information. Otherwise, the method ends in block 306 with access to the account denied.

The application receives authentication information for the request from the detected mobile device (block 304). Client computer system 103 receives, from mobile computing device 104, a value that indicates that mobile device 104 is on the same wireless network as client computer 103. This value, corresponding to the authentication information, may include information such as, for example, a wireless network ID of mobile device 104. In other embodiments, client computer system 103 sends the challenge codeword to mobile device 104, and the authentication information includes the proper response to the challenge codeword.

The application sends an authentication request, including data based on the authentication information, to the server computer system (block 305). After receiving the authentication information from mobile device 104, client computer system 103 generates an authentication request based on the authentication information. The authentication request may include information, such as, for example, account credentials, the particular response, a wireless ID of the mobile device, or any suitable data that indicates that client computer system 103 has successfully detected mobile computing device 104 on wireless network 105. If the authentication request includes a valid response that is expected by server computer system 101, then the user may be granted access to the account. Otherwise, if an invalid response was sent, then access is denied and the user may be allowed to retry the login attempt. The method ends in block 306.

It is noted that Method 300 is presented as an example embodiment. In other embodiments, a different number of operations may be included. In some embodiments, actions may be executed in a different order.

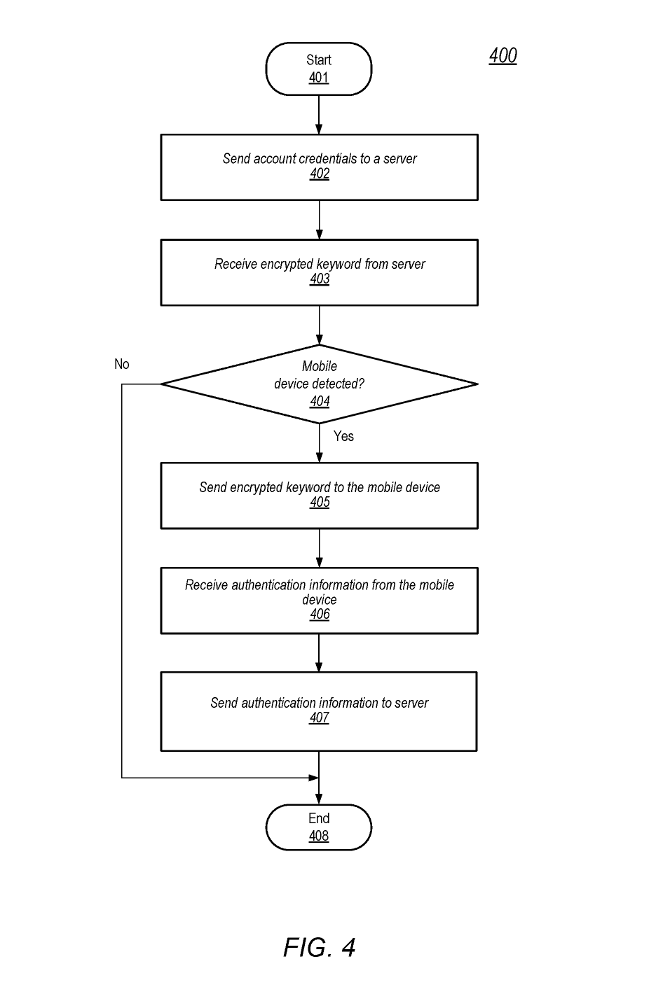

Turning now to FIG. 4, a flow diagram for another embodiment of a method for authenticating a user for access to an online account is illustrated. Similar too method 300, method 400 may also be applied to a client computer, such as, e.g., client computer systems 103 or 203 in FIGS. 1 and 2. Referring collectively to FIGS. 2 and 4, method 400 begins in block 401.

A client computer system sends account credentials to an online server (block 402). A user of client computer system 203, in the illustrated embodiment, sends, using application 207, account credentials to server computer system 201 in order to access an online user account. The online user account may correspond to any type of network accessible account that enables access to sensitive information related to an individual, a business, or other organization. For example, in one embodiment, the online user account may enable access to a multi-tenant database. In some embodiments, the account credentials may be entered by the user using client computer system 203. In other embodiments, the account credentials may be known to application 207 which may send the credentials in response to a trigger event such as, for example, launching of application 207, selection of a login option by the user in application 207, detection of a uniform resource locator (URL) corresponding to a login page hosted by server computer system 201.

The client computer system receives an encrypted version of a keyword from the online server (block 403). In the illustrated embodiment, server computer system 201 receives the account credentials from client computer system 203 and, in response to determining the credentials correspond to a valid user account, sends a challenge to client computer system 203. This challenge may correspond to any suitable data value to which client computer system 203 is unable to correctly respond, but to which mobile device 204 is capable of correctly responding. In various embodiments, the challenge may correspond to an index into a predefined data table, an encrypted value, a series of data values, or any other suitable challenge for which a correct response requires shared knowledge with server computer system 201. For example, the index may require access to the data table, the encrypted value may require a particular cryptographic key, and the series of data values may require knowledge of subsequent values in the series. In the illustrated embodiment, the challenge is the encrypted version of keyword 210.

Further operations of method 400 may depend on detection of a mobile device on a particular wireless network (block 404). In the illustrated embodiment, application 207 causes client computer 203 to use wireless network 205 to detect mobile device 204. If client computer system 203 successfully detects mobile device 204 connected to wireless network 205, then the method moves to block 405 to send the encrypted version of keyword 210. Otherwise, the method ends in block 408 with access to the user account denied.

The client computer system sends the encrypted version of the keyword to the detected mobile device (block 405). In response to determining that mobile device 204, along with client computer system 203, is connected to wireless network 205, application 207 causes client computer system 203 to send the encrypted version of keyword 210 to mobile device 204. Application 207, in some embodiments, may include the encrypted version of keyword 210 in a message with additional data. In response to receiving the encrypted version of keyword 210, mobile device 204 may decrypt keyword 210 and prepare a response message that includes authentication information 212.

In some embodiments, application 207 may utilize a counter to determine if mobile device 204 takes more than a threshold amount of time to respond. For example, mobile device 204 may not receive the transmission from client computer system 203, or the data may be corrupted during transmission. Mobile application 208 may not be active on mobile device 204 and may, therefore, need to be launched by the user to continue. Mobile device 204 may be moved out of range of wireless network 205 before or during the transmission of the encrypted version of keyword 210. If application 207 does not receive a response within a predetermined amount of time, then a notification may be displayed on client computer system 203 to alert the user that no response has been received. This notification may include one or more options for the user to select to continue, such as, e.g., “resend,” “abort,” “wait,” and “restart.” The amount of time to wait may be determined by a product designer, based on the type of response is expected from mobile device 204. If, for example, the response from mobile device 204 is passive, i.e., the user does not need to interface with mobile device 204 to generate the response, then the amount of time may be long enough for mobile device 204 to determine the response and reply, for example, seconds or tens of seconds. If mobile device 204 requires input from the user, e.g., a selection of an “allow” or “continue” option displayed on a screen of mobile device 204, then the amount of time may be minutes.

The application receives authentication information for the request from the detected mobile device (block 406). In the illustrated embodiment, if mobile application 208 determines and sends a response, then application 207 receives authentication information 212 from mobile device 204. Authentication information 212 may correspond to a value that client computer system 203 is not capable of determining, or that would take a suitably long time to determine using client computer system 203 or any other computer system that does not have the shared knowledge from server computer system 201. In the current example, server computer system 201 and mobile device 204 both have a cryptographic key for encoding and decoding keyword 210, while client computer system 203 does not have access to this key. While other methods for determining the cryptographic keyword based on receiving one or more encrypted keywords from server computer system 201 may be possible, the type of cryptographic algorithm used may be selected based on a desired amount of time a hacker might need to discover the key through “brute force” methods.

The application sends the authentication request to the server computer system (block 407). Application 207 generates authentication response 213 using authentication information 212. In various embodiments, an encrypted or decrypted version of authentication information 212 may be included in authentication response 213. Application 207 causes client computer system 203 to send authentication response 213 to server computer system 201. If authentication response 213 includes a correct response to the challenge, then access to the online user account may be granted. Otherwise, access may be denied and the user may be able to repeat the login attempt. The method ends in block 408.

It is noted that the method of FIG. 4 is merely an example. In other embodiments, some operations may be performed in parallel or a different order. For example, operations 402 and 403 may be performed in parallel with operation 404. In some embodiments, additional operations may be included.

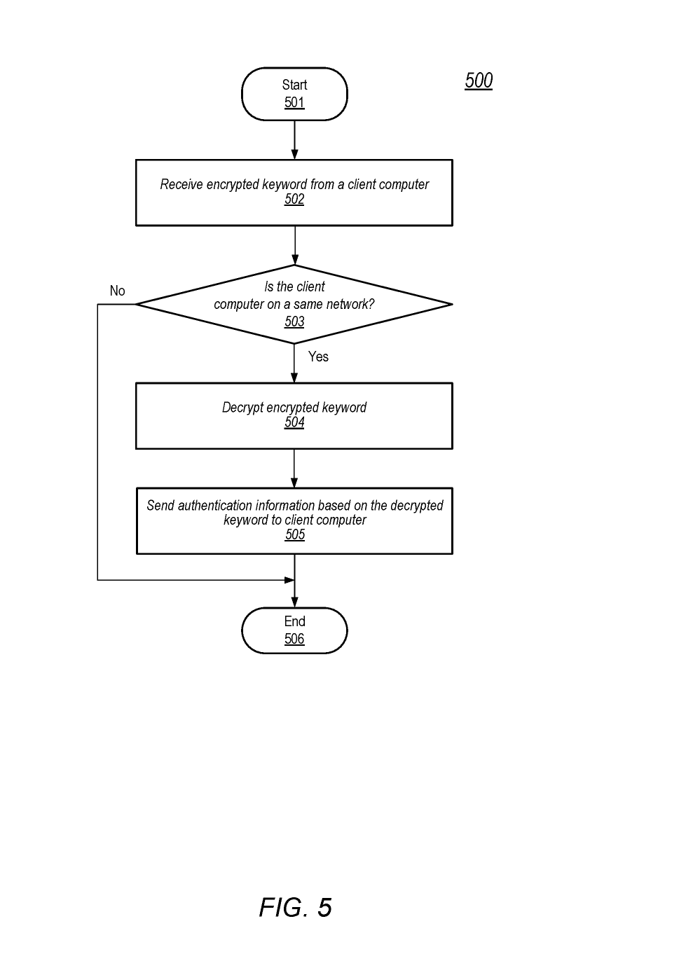

Moving now to FIG. 5, a flow diagram for an embodiment of a method for generating authentication information on a mobile device is shown. Method 500 of FIG. 5 may be applicable to a mobile device, such as, e.g., mobile devices 104 and 204 in FIGS. 1 and 2. Referring collectively to FIGS. 2 and 5, the method begins in block 501.

A mobile device receives a request for authorization information from a client computer system (block 502). In the illustrated embodiment, mobile device 204 receives the encrypted version of keyword 210 from client computer system 203. In other embodiments, mobile device 204 may receive, instead of an encrypted keyword, a different type of challenge, as described above. In some embodiments, mobile application 208, or a portion thereof, may be executing as a background process on mobile device 204 and become active in response to receiving the encrypted version of keyword 210. In other embodiments, a user may launch mobile application 208 before or after the encrypted version of keyword 210 is received.

Further operations of method 500 may depend on a wireless network to which the mobile device is connected (block 503). In the illustrated embodiment, mobile application 208 may determine if mobile device 204 is connected to the same wireless network that client computer system 203 is connected, e.g., wireless network 205. For example, the encrypted version of keyword 210 may be received within a data packet from client computer system 203. Information in this data packet may include an indication of what network, or type of network, on which the data packet was originated.

If mobile application 208 determines that client computer system 203 is connected to wireless network 205 the same as mobile device 204, then the method moves to block 504 to decrypt the encrypted version of keyword 210. Otherwise, method 500 ends in block 506. In some embodiments, mobile application 208 may cause mobile device 204 to send a message indicating that authentication information will not be sent if client computer system 203 is not connected to wireless network 205.

The mobile device decrypts the encrypted version of the keyword to generate a decrypted version of the keyword (block 504). Mobile application 208, in the illustrated embodiment, has access to a cryptographic key shared with server computer system 201. This cryptographic key may be received from server computer system 201 during an installation or registration of mobile application 208 with server computer system 201. This registration process may occur in advance of mobile device 204 being usable as an authentication device for the user. In other embodiments, the user may select a value that determines the cryptographic key, and the cryptographic key is sent from mobile device 204 to server computer system 201. Mobile application 208 decrypts the encrypted version of version of keyword 210 by using the cryptographic key and a decryption algorithm known to mobile application 208 and server computer system 201.

The mobile device sends authentication information based on the decrypted version of the keyword to the client computer system (block 505). In various embodiments, mobile application 208 may utilize any of a number of algorithms to generate authentication information 212. To provide an indication that mobile device 204 successfully received and decrypted the encrypted version of keyword 210, mobile application 208 may generate authentication information 212 by modifying the decrypted version of the keyword. For example, mobile application 208 may perform one or more mathematical operations on the decrypted version of the keyword. The mathematical operations, in such an embodiment, are known by server computer system 201, but not necessarily by client computer system 203. Including such a modification to the decrypted version of the keyword may provide additional protection against a hacker trying to fool server computer system 201 into granting access to the online account by attempting to generate authentication response 213 without mobile device 204. Mobile application 208 may encrypt data included in authentication information 212 (using either the same, or a different cryptographic key). After generating authentication response 212, mobile application 208 sends authentication response 212 to client computer system 203. The method ends in block 506.

It is noted that Method 500 is presented as an example embodiment. In some embodiments, actions may be executed in a different order than illustrated. In other embodiments, a different number of operations may be included. For example, in some embodiments, operation 503 may be omitted and the mobile application may decrypt the received keyword after receiving it.

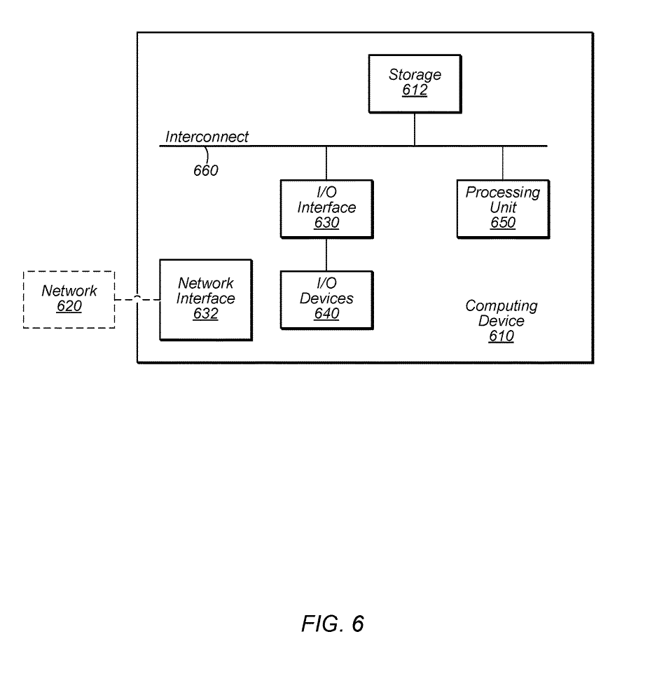

Turning now to FIG. 6, a block diagram of a computing device (which may also be referred to as a computing system) 610 is depicted, according to some embodiments. Computing device 610 may be used to implement various portions of this disclosure. Computing device 610 is one example of a device that may be used as a mobile device, a server computer system, a client computer system, or any other computing system implementing portions of this disclosure.

Computing device 610 may be any suitable type of device, including, but not limited to, a personal computer system, desktop computer, laptop or notebook computer, mobile phone, mainframe computer system, web server, workstation, or network computer. As shown, computing device 610 includes processing unit 650, storage subsystem 612, and input/output (I/O) interface 630 coupled via interconnect 660 (e.g., a system bus). I/O interface 630 may be coupled to one or more I/O devices 640. Computing device 610 further includes network interface 632, which may be coupled to network 620 for communications with, for example, other computing devices.

Processing unit 650 includes one or more processors, and in some embodiments, includes one or more coprocessor units. In some embodiments, multiple instances of processing unit 650 may be coupled to interconnect 660. Processing unit 650 (or each processor within processing unit 650) may contain a cache or other form of on-board memory. In some embodiments, processing unit 650 may be implemented as a general-purpose processing unit, and in other embodiments it may be implemented as a special purpose processing unit (e.g., an ASIC). In general, computing device 610 is not limited to any particular type of processing unit or processor subsystem.

As used herein, the terms “processing unit” or “processing element” refer to circuitry configured to perform operations or to a memory having program instructions stored therein that are executable by one or more processors to perform operations. Accordingly, a processing unit may be implemented as a hardware circuit implemented in a variety of ways. The hardware circuit may include, for example, custom very-large-scale integration (VLSI) circuits or gate arrays, off-the-shelf semiconductors such as logic chips, transistors, or other discrete components. A processing unit may also be implemented in programmable hardware devices such as field programmable gate arrays, programmable array logic, programmable logic devices, or the like. A processing unit may also be configured to execute program instructions or computer instructions from any suitable form of non-transitory computer-readable media to perform specified operations.

Storage subsystem 612 is usable by processing unit 650 (e.g., to store instructions executable by and data used by processing unit 650). Storage subsystem 612 may be implemented by any suitable type of physical memory media, including hard disk storage, floppy disk storage, removable disk storage, flash memory, random access memory (RAM-SRAM, EDO RAM, SDRAM, DDR SDRAM, RDRAM, etc.), ROM (PROM, EEPROM, etc.), and so on. Storage subsystem 612 may consist solely of volatile memory in some embodiments. Storage subsystem 612 may store program instructions executable by computing device 610 using processing unit 650, including program instructions executable to cause computing device 610 to implement the various techniques disclosed herein.

I/O interface 630 may represent one or more interfaces and may be any of various types of interfaces configured to couple to and communicate with other devices, according to various embodiments. In some embodiments, I/O interface 630 is a bridge chip from a front-side to one or more back-side buses. I/O interface 630 may be coupled to one or more I/O devices 640 via one or more corresponding buses or other interfaces. Examples of I/O devices include storage devices (hard disk, optical drive, removable flash drive, storage array, SAN, or an associated controller), network interface devices, user interface devices or other devices (e.g., graphics, sound, etc.).

It is noted that the computing device of FIG. 6 is one embodiment for demonstrating disclosed concepts. In other embodiments, various aspects of the computing device may be different. For example, in some embodiments, additional components, or multiple instances of the illustrated components may be included.

This specification includes references to “one embodiment,” “other embodiments,” “some embodiments,” or “an embodiment.” The appearances of these phrases do not necessarily refer to the same embodiment. Particular features, structures, or characteristics may be combined in any suitable manner consistent with this disclosure.

Various units, circuits, or other components may be described or claimed as “configured to” perform a task or tasks. In such contexts, “configured to” is used to connote structure by indicating that the units/circuits/components include structure (e.g., circuitry) that performs the task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112(f) for that unit/circuit/component.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method comprising:
receiving, by an application executing on a client computer system, an indication that a user is requesting access to a server computer system;
in response to the receiving, detecting, by the application, that a mobile device associated with the user is connected to a wireless network to which the client computer system is also connected;
receiving, by the application, authentication information for the request from the detected mobile device; and
sending, by the application, an authentication request to the server computer system, wherein the authentication request includes data based on the authentication information received from the detected mobile device.

2. The method of claim 1, further comprising:
receiving, by the application, an encrypted version of a keyword sent from the server computer system in response to the requested access; and
sending, by the application, the encrypted version of the keyword to the detected mobile device;
wherein the authentication information received by the application includes a decrypted version of the keyword generated by the mobile device, and wherein the authentication request to the server computer system includes, as part of the data based on the authentication information, the decrypted version of the keyword.

3. The method of claim 2, wherein the encrypted version of the keyword is received in response to valid account credentials being sent to the server computer system by the application.

4. The method of claim 2, wherein the encrypted version of the keyword is sent to the mobile device automatically by the client computer system, without input from the user.

5. The method of claim 1, wherein the wireless network is a short-range wireless network.

6. The method of claim 5, wherein the application is a web browser that supports a Web Bluetooth application programming interface (API), and wherein the short-range wireless network is a network based on a Bluetooth Low Energy (BLE) standard.

7. The method of claim 1 wherein the application is a browser, and wherein the authentication information is used for one factor of a multi-factor authentication process.

8. A non-transitory computer-readable medium having instructions stored thereon that are executable by a client computer system to perform operations comprising:
requesting access to a user account on a server computer system;
in response to the requesting, detecting that a mobile device associated with the user account is connected to a wireless network to which the client computer system is also connected;
receiving authentication information for the request from the detected mobile device; and
sending an authentication request to the server computer system, wherein the authentication request includes data based on the authentication information received from the detected mobile device.

9. The non-transitory computer-readable medium of claim 8, wherein requesting access to the server computer system comprises:
sending account credentials to the server computer system; and
receiving an encrypted version of a keyword.

10. The non-transitory computer-readable medium of claim 9, wherein receiving the authentication information for the request from the detected mobile device comprises:
sending the encrypted version of the keyword to the detected mobile device; and
receiving a decrypted version of the keyword from the detected mobile device.

11. The non-transitory computer-readable medium of claim 10, wherein sending the encrypted version of the keyword to the detected mobile device comprises sending the encrypted version of the keyword without input from a user of the client computer system.

12. The non-transitory computer-readable medium of claim 8, wherein detecting that the mobile device associated with the user account is connected to the wireless network comprises communicating with the mobile device over a peer-to-peer wireless network.

13. The non-transitory computer-readable medium of claim 8, wherein detecting that the mobile device associated with the user account is connected to the wireless network comprises receiving program instructions from the server computer system that are executable by the client computer system to communicate to other devices via the wireless network.

14. The non-transitory computer-readable medium of claim 13, wherein the authentication information corresponds to a hardware identification (ID) value assigned to the detected mobile device.

15. A method comprising:
establishing, by a mobile device with a web browser executing on a client computer system, communication for a first authentication process that is part of a multi-factor authentication process for the client computer system to access a server computer system, wherein the establishing is performed via a wireless network to which both the client computer system and the mobile device are connected;
receiving, by the mobile device, a request for authorization information associated with an attempt by the client computer system to access the server computer system;
generating, by the mobile device, a decrypted version of a keyword by decrypting an encrypted version of the keyword included in the request; and
sending, by the mobile device, authentication information based on the decrypted version of the keyword to the client computer system.

16. The method of claim 15, further comprising:
modifying, by the mobile device, the decrypted version of the keyword to generate a modified keyword; and
sending the modified keyword to the client computer system as part of the authentication information.

17. The method of claim 15, wherein decrypting the encrypted version of the keyword comprises using, by the mobile device, a cryptographic key received from the server computer system, wherein the encrypted version of the keyword is generated by the server computer system.

18. The method of claim 17, further comprising, prior to communicating to the web browser executing on the client computer system, receiving the cryptographic key from the server computer system during a registration process.

19. The method of claim 17, further comprising, in response to receiving the request for the authorization information, receiving the cryptographic key from the server computer system via the Internet.

20. The method of claim 15, further comprising the mobile device automatically approving a second authentication process of the multi-factor authentication process based on a set of one or more automation criteria being satisfied, wherein the set of one or more automation criteria is based on a physical location indicated by the mobile device.
